(19) United States
(12) Patent Application Publication
(10) Pub. No.: US 2016/0105410 A1
(43) Pub. Date: Apr. 14, 2016

(54) OMA DM Based Terminal Authentication Method, Terminal and Server

(71) Applicant: ZTE CORPORATION, Guangdong (CN)

(72) Inventors: Liming ZHOU, Shenzhen (CN); Yuming QIAN, Shenzhen (CN); Kezhi ZHU, Shenzhen (CN); Yanqing FENG, Shenzhen (CN)

(21) Appl. No.: 14/786,168

(22) PCT Filed: Aug. 23, 2013
(86) PCT No.: PCT/CN2013/082196

§ 371 Date: Oct. 22, 2015

(30) Foreign Application Priority Data
Apr. 23, 2013 (CN) 201310143538.3

(51) Int. Cl. H04L 29/06

(52) U.S. Cl. CPC H04L 63/08; H04L 63/12

(57) ABSTRACT

A method for implementing terminal authentication based on an OMA DM protocol, a terminal and a server are disclosed. The method includes: a terminal initiating a registration request to a target server, wherein a user name, a password and a device identifier are carried; the terminal receiving and storing an access token generated through registration; and the terminal carrying the access token and the device identifier in a message of initiating services to the target server for authentication. In the present document, user identity authentication is performed based on the access token, which brings a higher security and more convenient terminal life cycle management.

### TECHNICAL FIELD

The present document relates to the field of mobile communication, and particularly, to a method for implementing terminal authentication, a terminal and a server.

### BACKGROUND OF THE RELATED ART

The current Open Mobile Alliance (OMA) Device Manage (DM) protocol provides that it is required to carry a user's account number and password when a terminal sends a package1 message to a server, so as to perform authentication. Generally it is required to save the account number and password in the terminal locally in this way, which brings a potential safety hazard. Or the user needs to reenter the account number and password, which causes a reduction of user experience.

### SUMMARY OF THE INVENTION

The present document provides a method for implementing terminal authentication based on an OMA DM protocol, a terminal and a server, to ensure the security of user information in the OMA DM authentication.

In order to solve the above technical problem, the present document provides a method for implementing terminal authentication based on an open mobile alliance device manage protocol, which comprises:

a terminal initiating a registration request to a target server, wherein a user name, a password and a device identifier are carried;

the terminal receiving and storing an access token generated through registration; and

the terminal carrying the access token and the device identifier in a message of initiating services to the target server for authentication.

The method further comprises: after receiving the registration request, the target server performing encryption on the user name, the password and the device identifier to generate the access token, and sending the generated access token to the terminal.

Wherein, the target server performs encryption to generate the access token.

The method further comprises: the target server generating a validity period corresponding to the access token;

wherein, the step of the terminal carrying the access token and the device identifier in a message of initiating services to the target server for authentication comprises:

the terminal carrying the access token and the device identifier in a request message of initiating services to the target server; and

the target server performing verification on the access token and the device identifier, if the verification is passed, verifying the validity period of the access token, and if the access token is within the validity period, performing management on the terminal.

The method further comprises: after receiving the registration request, the target server redirecting the registration request to a third-party authentication server for registration, receiving and storing an access token generated after the third-party authentication server makes a successful registration.

The present document further provides a terminal, which comprises:

a first module, configured to: initiate a registration request to a target server, wherein a user name, a password and a device identifier are carried;

a second module, configured to: receive and store an access token generated through registration; and

a third module, configured to: carry the access token and the device identifier in a message of initiating services to the target server for authentication.

Wherein, the access token is generated through encryption according to the user name, the password and the device identifier.

The present document further provides a server, which comprises:

a first module, configured to: after receiving a registration request of a terminal, send an access token generated through registration to the terminal, wherein the registration request carries a user name, a password and a device identifier; and

a second module, configured to: after receiving an authentication request carrying the access token and the device identifier sent by the terminal, perform authentication on the access token and the device identifier.

The first module comprises:

a first unit, configured to: after receiving the registration request, perform encryption on the user name, the password and the device identifier to generate the access token and/or a validity period corresponding to the access token; and

a second unit, configured to: send the access token and/or the validity period corresponding to the access token generated by the first unit to the terminal.

Wherein, the first unit is configured to perform encryption to generate the access token.

The present document further provides a server, which comprises:

a first module, configured to: after receiving a registration request of a terminal, redirect the registration request to a third-party authentication server for registration;

a second module, configured to: receive and store an access token generated after the third-party authentication server makes a successful registration; and

a third module, configured to: after receiving an authentication request carrying the access token and a device identifier sent by the terminal, perform authentication on the access token and the device identifier.

Wherein, the second module is further configured to receive and store a validity period corresponding to the access token generated after the third-party authentication server makes a successful registration;

the third module is further configured to perform verification on the validity period of the access token.

In conclusion, the present document provides a method for implementing terminal authentication based on an OMA DM protocol, a terminal and a server, and user identity authentication is performed based on the access token, which brings a higher security and more convenient terminal life cycle management.

### BRIEF DESCRIPTION OF DRAWINGS

FIG. 1 is a flow chart of a method for implementing terminal authentication according to the embodiment of the present invention.

FIG. 2 is a schematic diagram of a terminal according to the embodiment of the present invention.

FIG. 3 is a schematic diagram of a server according to one preferred embodiment of the present invention.

FIG. 4 is a schematic diagram of a server according to another preferred embodiment of the present invention.

FIG. 5 is a schematic diagram of deployment architecture of a system according to the application example of the present invention.

FIG. 6 is a flow chart of login/register and service processing of the terminal according to the application example of the present invention.

### PREFERRED EMBODIMENTS OF THE INVENTION

The embodiments of the present invention will be described in detail in combination with the accompanying drawings below. It should be noted that the embodiments in the present invention and the characteristics in the embodiments can be optionally combined with each other in the condition of no conflict.

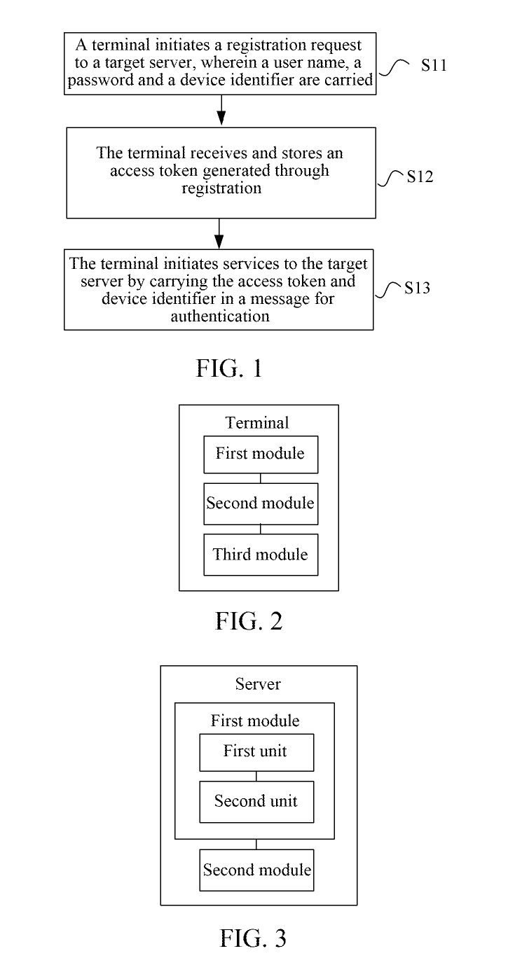

FIG. 1 is a flow chart of a method for implementing terminal authentication according to the embodiment of the present invention, and as shown in FIG. 1, the method of the embodiment includes the following steps.

In step S11, a terminal initiates a registration request to a target server, wherein a user name, a password and a device identifier are carried.

In step S12, the terminal receives and stores an AccessToken generated through registration.

In step S13, the terminal carries the AccessToken and the device identifier in a message of initiating services to the target server for authentication.

It is divided into a temporary AccessToken and a permanent AccessToken, and a temporary validity period can be set by configuration. With regard to generation rules of the AccessToken, it can be generated by means of performing the encryption on a character string composed of a UserName, a PassWord and a DeviceID of the terminal (a device number recorded by the system), and the generation rules here are not only limited to ways in the illustrated examples.

Therefore, the terminal is not required to save the user's account number and password locally, and it saves an AccessToken character string locally, which brings a higher security. The server can perform a more convenient terminal life cycle management based on the AccessToken and a validity corresponding to the AccessToken. By opening an authentication function to an external server, it can be flexibly to joint with a third-party authentication server.

FIG. 2 is a schematic diagram of a terminal according to the embodiment of the present invention, and as shown in FIG. 2, the terminal of the embodiment can include:

a first module, configured to: initiate a registration request to a target server, wherein a user name, a password and a device identifier are carried;

a second module, configured to: receive and store an access token generated through registration; and

a third module, configured to: carry the access token and the device identifier in a message of initiating services to the target server for authentication.

FIG. 3 is a schematic diagram of a server (e.g. a device management server (DMServer)) according to one preferred embodiment of the present invention, and as shown in FIG. 3, the server of the embodiment includes:

a first module, configured to: after receiving a registration request of a terminal, send an access token generated through registration to the terminal, wherein the registration request carries a user name, a password and a device identifier; and

a second module, configured to: after receiving an authentication request carrying the access token and the device identifier sent by the terminal, perform authentication according to the access token and the device identifier.

In one preferred embodiment, the first module can include:

a first unit, configured to: after receiving the registration request, perform encryption on the user name, the password and the device identifier to generate the access token and/or a validity period corresponding to the access token; and

a second unit, configured to: send the access token and/or the validity period corresponding to the access token to the terminal.

Wherein, the first unit is configured to perform encryption to generate the access token.

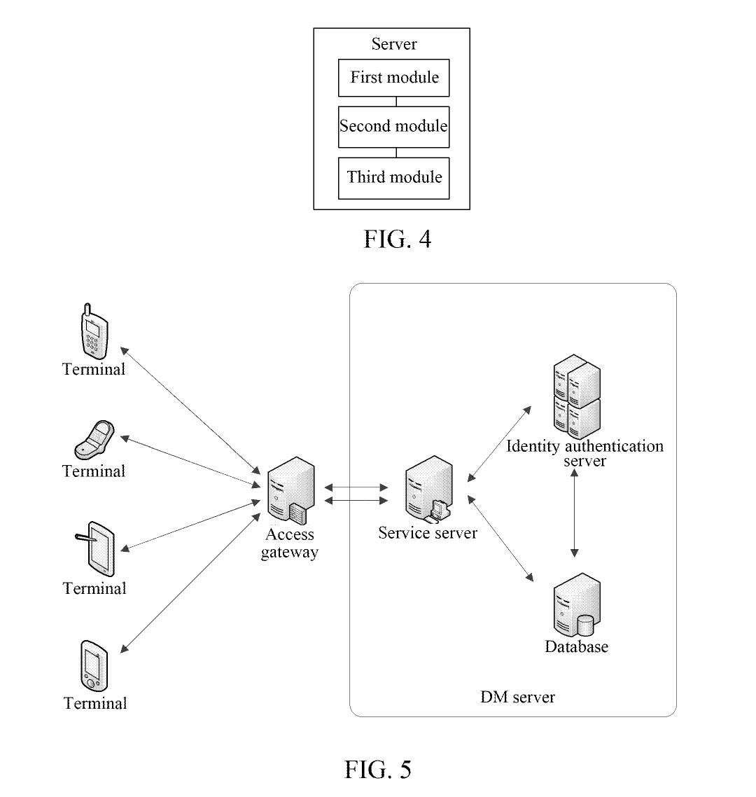

FIG. 4 is a schematic diagram of a server (e.g. an MDM server)) according to another preferred embodiment of the present invention, and as shown in FIG. 4, the server of the embodiment can include:

a first module, configured to: after receiving a registration request of a terminal, redirect the registration request to a third-party authentication server for registration;

a second module, configured to: receive and store an access token generated after the third-party authentication server makes a successful registration; and

a third module, configured to: after receiving an authentication request carrying the access token and a device identifier sent by the terminal, perform authentication on the access token and the device identifier.

Wherein, the second module is further configured to receive and store a validity period corresponding to the access token generated after the third-party authentication server makes a successful registration;

the third module is further configured to perform verification on the validity period of the access token.

Certainly, the function modules can be differently divided according to the implementation needs.

FIG. 5 is a schematic diagram of a system according to one application example of the present invention, as shown in FIG. 5, a user identity authentication module is added at the DMServer (device management server) side in the system, to store a user's account number and password (stored in a form of ciphertext) and a corresponding AccessToken. Moreover, it is required to save the validity period of the AccessToken, and the DMServer of the system is mainly divided into two modules in the architecture:

1. Service server: performing OMA DM services, and completing message transceiving and interaction of package0 (a notification message from a server to a terminal), package1 (a link establishment and authentication message of the terminal server), package2 (an instruction message sent by a server to a terminal), package3 (an instruction execution result message reported by a terminal) and package4 (a message of deciding whether to continue sending an instruction) with the terminal.

2. Identity authentication server: performing validity verification on a user account and password when a user logs onto the terminal for activation for the first time, and generating a corresponding AccessToken and validity period; and performing verification and inspection on whether the AccessToken is invalid in the following services.

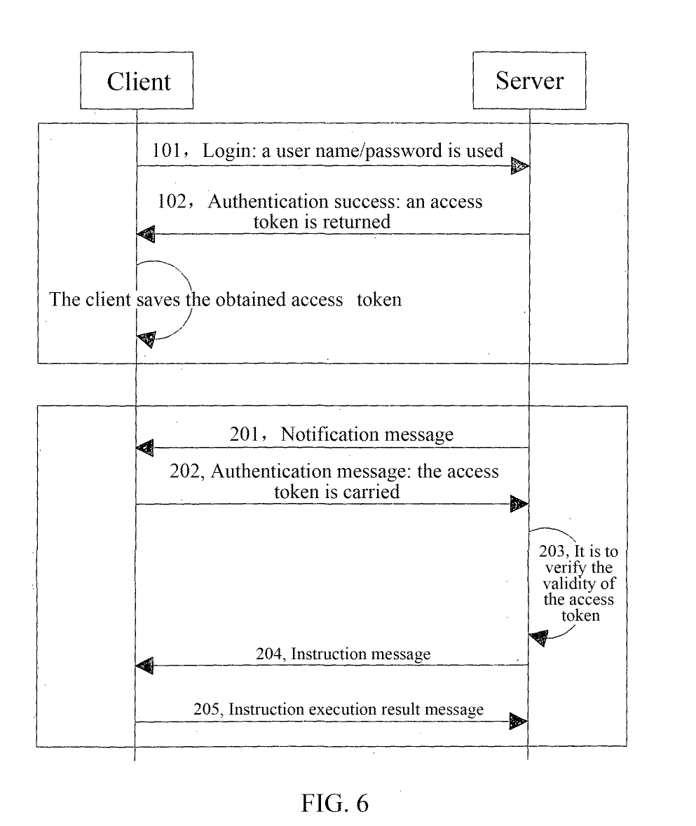

The register/login process of the application example is as shown in FIG. 6, and the following steps are included.

In step 101, after installing a client, firstly a user needs to perform registration and activation, and the user enters an account number and password at the client. The client reports information including the account number and password (encrypted into a ciphertext) and a device ID to a Mobile Device Management (MDM) server via the network.

In step 102, the MDM server performs the validity verification on the user's account number and password, and if the account number and password are illegal, it returns an error to the client and prompts the user; if the account number and password are legal, it generates a corresponding AccessToken and validity period according to rules, and returns the AccessToken to the client through a success response message.

The service processing process is as shown in FIG. 6, and the following steps are included.

In step 201, an MDM client initiates services actively, or initiates services after receiving a notification message (package0) of an MDM server.

In step 202, the client sends a package1 message to the MDM server at this point, but the message carries an AccessToken bound to the terminal.

An message example of the syncml authentication part is as follows:

<Source>
<LocURI>DeviceID</LocURI>
</Source>
<Cred>
<Meta>
<Type xmlns=‘syncml:metinf’>accesstoken</Type>
</Meta>
<Data>aLvhZSxpUDQ/XaSZdNw98NSL0ddeX==</Data>
</Cred>

In step 203, after receiving the package1 message, the MDM server performs verification on the DeviceID and AccessToken in the message, and checks whether the AccessToken has been invalid.

In step 204, if both the DeviceID and AccessToken are legal, the MDM server returns a package2 message to the client, and continues to perform the following flow of step 205; if the DeviceID and AccessToken are illegal, the server returns an error to the client, and ends the current DM session. If the AccessToken has expired, an error is returned to the client, and the client initiates a login flow again.

In step 205, the client returns a package3 (an instruction execution result).

The processing process of jointing with the third-party authentication server in the application example includes the following steps.

In step 301, an MDM client initiates a login request to an MDM server, and the request message carries information including a user account, a password and a device ID and so on.

In step 302, after receiving the request, the MDM server redirects the client to a third-party authentication server.

In step 303, the MDM client completes login and registration at the third-party authentication server.

In step 304, the third-party authentication server returns a result of successful user login to the MDM server, and the result includes a generated AccessToken and a corresponding validity period.

In step 305, the MDM server transparently transmits an authentication result and the AccessToken to the MDM client.

The ordinary person skilled in the art can understand that all or part of the steps in the above method can be completed by a program instructing related hardware, and the program can be stored in a computer readable memory medium, such as a read-only memory, disk or optical disk and so on. Alternatively, all or part of the steps of the above embodiments also can be implemented by using one or multiple integrated circuits. Correspondingly, each module/unit in the above embodiments can be implemented in a form of hardware, and also can be implemented in a form of software function module. The present document is not limited to any combination of hardware and software in a specific form.

The above description is only the preferred embodiments of the present invention. Certainly, the present document can still have other various embodiments, the skilled familiar to the art can make various corresponding changes and transformations according to the present document without departing from the spirit and essence of the present document, and these corresponding changes and transformations shall all fall into the protection scope of the appended claims of the present document.

### INDUSTRIAL APPLICABILITY

Compared with the related art, with the method for implementing terminal authentication based on an OMA DM protocol, the terminal and the server provided in the present document, the user identity authentication is performed based on an access token, which brings a higher security and more convenient terminal life cycle management.

What is claimed is:

1. A method for implementing terminal authentication based on an open mobile alliance device manage protocol, comprising:
a terminal initiating a registration request to a target server, wherein a user name, a password and a device identifier are carried;
the terminal receiving and storing an access token generated through registration; and
the terminal carrying the access token and the device identifier in a message of initiating services to the target server for authentication.

2. The method according to claim 1, further comprising:
after receiving the registration request, the target server performing encryption on the user name, the password and the device identifier to generate the access token, and sending the generated access token to the terminal.

3. (canceled)

4. The method according to claim 2, further comprising:
the target server generating a validity period corresponding to the access token;
wherein, the step of the terminal carrying the access token and the device identifier in a message of initiating services to the target server for authentication comprises:
the terminal carrying the access token and the device identifier in a request message of initiating services to the target server; and
the target server performing verification on the access token and the device identifier, if the verification is passed, verifying the validity period of the access token, and if the access token is within the validity period, performing management on the terminal.

5. The method according to claim 1, further comprising:
after receiving the registration request, the target server redirecting the registration request to a third-party authentication server for registration, receiving and storing an access token generated after the third-party authentication server makes a successful registration.

6. A terminal, comprising:
a first module, configured to: initiate a registration request to a target server, wherein a user name, a password and a device identifier are carried;
a second module, configured to: receive and store an access token generated through registration; and
a third module, configured to: carry the access token and the device identifier in a message of initiating services to the target server for authentication.

7. The terminal according to claim 6, wherein,
the access token is generated through encryption according to the user name, the password and the device identifier.

8-10. (canceled)

11. A server, comprising:
a first module, configured to: after receiving a registration request of a terminal, wherein the registration request carries a user name, a password and a device identifier, perform authentication according to the information in the registration request;
a second module, configured to: receive and store an access token generated after a successful registration is made; and
a third module, configured to: after receiving an authentication request carrying the access token and a device identifier sent by the terminal, perform authentication on the access token and the device identifier.

12. The server according to claim 11, wherein,
the second module is further configured to receive and store a validity period corresponding to the access token generated after the third-party authentication server makes a successful registration;
the third module is further configured to perform verification on the validity period of the access token.

13. The server according to claim 11, wherein the first module is configured to optionally redirect the registration request to a third-party authentication server for registration;
the second module is configured to receive and store an access token after the third-party authentication server makes a successful registration.
